(19) United States
(12) Patent Application Publication
(10) Pub. No.: US 2025/0170692 A1
(43) Pub. Date: May 29, 2025

(54) TOOL FOR SANITARY INSERT PART

(71) Applicant: Neoperl GmbH, Müllheim (DE)

(72) Inventor: Christoph Philipp Kreis, Staufen (DE)

(73) Assignee: Neoperl GmbH, Müllheim (DE)

(21) Appl. No.: 18/956,239

(22) Filed: Nov. 22, 2024

(30) Foreign Application Priority Data
Nov. 23, 2023 (DE) 102023132746.1

(51) Int. Cl. B25B 27/14; E03C 1/086

(52) U.S. Cl. CPC B25B 27/14; E03C 1/086

(57) ABSTRACT

A tool (1) and a method for assembling and/or for disassembling a sanitary insert part (2), in particular a sanitary outflow orifice (3), are provided. Here, the tool (1) is designed with a latching element (4) and/or mating latching element (5) for a preferably releasable and/or captive connection (6) to the sanitary insert part (2).

### CROSS-REFERENCE TO RELATED APPLICATIONS

This application claims priority from German Patent Application No. 10 2023 132 746.1, filed Nov. 23, 2023, which is incorporated herein by reference as if fully set forth.

### TECHNICAL FIELD

The invention relates to a tool for assembling and/or disassembling a sanitary insert part, in particular a sanitary outlet orifice.

### BACKGROUND

Tools for assembling and/or disassembling sanitary insert parts such as sanitary outlet orifices, also referred to as jet regulators, are known in the prior art. During assembling/disassembling known in the prior art, the sanitary insert part, which is often fastened in a sanitary fitting by way of a thread, is manually screwed to the sanitary fitting using fingers. A tool can subsequently be used for tightening the sanitary insert part. The sanitary insert part can easily fall out of the user's hand during tightening and handling with the aid of the fingers. Moreover, the torque required for tightening the sanitary insert part cannot be readily applied when using the fingers.

### SUMMARY

It is an object of the invention to improve tools for assembling and disassembling sanitary insert parts. It is also an object to improve the connection between the tool and the sanitary insert part.

According to the invention, one or more of the features disclosed herein are provided in order to achieve the object mentioned. According to the invention, in order to achieve the object mentioned it is thus proposed in particular that the tool is designed with latching means for connecting to the sanitary insert part. It can be achievable as a result, for example, that the tool can be connected to the sanitary insert part. By virtue of the connection, a torque or any other force, for example a compressive force or a tensile force, can be transmitted from the tool to the sanitary insert part. Alternatively or additionally, it can be provided that the tool is designed with mating latching means for connecting to the sanitary insert part. It can be achievable as a result, for example, that the tool can be connected to the sanitary insert part. Alternatively or additionally, it can be provided that the tool is designed with latching means and/or mating latching means for a releasable connection to the sanitary insert part. It can be achievable as a result, for example, that the latching means and/or mating latching means of the tool are releasable from the sanitary insert part, in particular that the latching means and/or mating latching means can be released again after being connected.

Alternatively or additionally, it is provided that the tool is designed with latching means and/or mating latching means for a captive connection to the sanitary insert part. It can be achievable as a result, for example, that the latching means and/or mating latching means of the tool can be connected to the sanitary insert part in such a way that they are captively connected to one another, thus cannot readily be mutually separated while being connected. Unintentional releasing of the connection between the tool and the sanitary insert part can be prevented in this way. Unintentional releasing may include, for example, the sanitary insert part falling off the tool due to gravity. The tool can be connected to the sanitary insert part, whereby the latter can then be fastened in a sanitary fitting using the tool. This can be particularly helpful in overhead assembly/disassembly work or in oblique positions. A captive connection between the tool and the sanitary insert part can be established with the aid of the tool in such a way that the sanitary insert part does not have to be manually screwed into the sanitary outlet fitting during assembly/disassembly but can be screwed in using the tool. In this way, the sanitary insert part can no longer fall out of one's hand. Moreover, the tool offers the fingers an advantageous engagement surface in comparison with the sanitary insert part. The tool can thus be connected to the sanitary insert part, whereby the tool supports the sanitary insert part. The captive connection has the effect that the sanitary insert part is easier to install. It can thus be prevented that the sanitary insert part is incorrectly screwed in, and consequential defects on the jet regulator or the fitting can also be prevented. Upon tightening of the sanitary insert part with the tool, the tool can be released from the sanitary insert part. The tool is connected to the sanitary insert part for disassembling the sanitary insert part, whereby the latter can then be released by a screwing motion.

A captive connection can be able to be characterized in that, for example, a minimum extraction force is required for releasing the connection. For example, the captive connection can have a releasing force which initially increases as the distance increases, and drops, for example drops abruptly, from a specific distance and/or once the connection, which may be very small, has been released.

Overall, the tool can be specified to introduce a rotating movement and/or a torque into the sanitary insert part. In this way, a screwing movement or unscrewing movement is able to be driven by the tool, for example.

In one advantageous design embodiment it can be provided that the tool has a drive portion. It can be achievable as a result, for example, that the drive portion is specified to transmit a force and can transmit a torque. In particular, the drive portion can have a wall. As a result it can be achievable, for example, that the drive portion can be of a hollow design and the transmission of force takes place by way of the wall. In particular, the drive portion can have a consistent cross-sectional contour along its profile. As a result, different geometries of the drive portion can be possible, which may have a positive effect on the stability of the tool. The drive portion can in particular be of a cylindrical shape. As a result, it can be achievable, for example, that the drive portion of the tool is able to engage on a cylindrically shaped sanitary insert part. Alternatively, the drive portion can be of a polygonal shape. As a result, it can be achievable, for example, that the drive portion is able to engage on a sanitary insert part of a corresponding polygonal shape. This can lead to the torque advantageously being able to be transmitted to the sanitary insert part in an effective and efficient manner. Alternatively or additionally, it can be provided that the latching means is disposed on one side of the drive portion. As a result, it can be achievable, for example, that the latching means of the tool can interact with a mating latching means of the sanitary insert part so as to establish a connection. Alternatively or additionally, it can be provided that the mating latching means is disposed on one side of the drive portion. As a result it can be achievable, for example, that the mating latching means of the tool can interact with a latching means of the sanitary insert part so as to establish a connection on the side of the drive portion. It can in particular be provided that the latching means and/or mating latching means are/is disposed on an encircling part of the drive portion. As a result it can be achievable, for example, that the latching means and/or mating latching means is able to be connected to the sanitary insert part in a particularly simple manner.

In one advantageous design embodiment it can be provided that the tool has two latching means. As a result it can be achievable, for example, that the two latching means of the tool can interact with two matching mating latching means of a sanitary insert part, so as to transmit a torque to the latter. With two latching means, the transmission of torque can be particularly high and/or particularly effective. Alternatively or additionally, it can be provided that the tool has two mating latching means. As a result it can be achievable, for example, that the two mating latching means of the tool can interact with two matching latching means of a sanitary insert part, so as to transmit a torque to the latter. It can be provided in particular that both latching means are differently spaced apart from an axial axis of the tool. As a result, different construction modes of sanitary insert parts can be gripped and impinged with a force by the same tool, for example. Alternatively or additionally, it can be provided that both mating latching means are differently spaced apart from an axial axis of the tool. As a result, different construction modes of sanitary insert parts can be gripped and impinged with a force by the same tool, for example. The axial axis herein can correspond to a longitudinal axis of the tool.

In one advantageous design embodiment it can be provided that the two latching means are disposed on two mutually spaced apart circular paths about the or an axial axis of the tool. As a result, different construction modes of sanitary insert parts can be gripped and impinged with a force by the same tool, for example. Alternatively or additionally, it can be provided that the two mating latching means are disposed on two mutually spaced apart circular paths about the or an axial axis of the tool. As a result, different construction modes of sanitary insert parts can be gripped and impinged with a force by the same tool, for example.

In one advantageous design embodiment it can be provided that the two latching means have identical longitudinal extents in the axial direction of the tool. As a result, the two latching means can engage in mating latching means on the sanitary insert part that have an identical position on the sanitary insert part in terms of an axial axis of the sanitary insert part, for example. Alternatively, it can be provided that the two latching means have different longitudinal extents in the axial direction of the tool. As a result, the two latching means can engage in mating latching means on the sanitary insert part that have different positions on the sanitary insert part in terms of an axial axis of the sanitary insert part, for example. Alternatively or additionally, it can be provided that the two mating latching means in the axial direction of the tool have identical longitudinal extents in the axial direction. As a result, the two mating latching means can engage in latching means on the sanitary insert part that have an identical position on the sanitary insert part in terms of an axial axis of the sanitary insert part, for example. Alternatively, it can be provided that the two mating latching means have different longitudinal extents in the axial direction of the tool. As a result, the two mating latching means can engage in latching means on the sanitary insert part that have different positions on the sanitary insert part in terms of an axial axis of the sanitary insert part, for example.

Alternatively or additionally, the features of the coordinate claim directed towards a sanitary insert part are provided according to the invention for achieving the object mentioned.

Proposed for achieving the object is thus a sanitary insert part which is characterized in that the sanitary insert part is designed with latching means so as to be connected to a mating latching means of a tool. As a result it can be achievable, for example, that the sanitary insert part and the tool can be connected to one another. By virtue of the connection, a torque or any other force, for example pressure or traction, can be transmitted from the tool to the sanitary insert part. It is provided in particular that the sanitary insert part is a sanitary outlet orifice. Alternatively or additionally, it is provided that the sanitary insert part is designed with mating latching means so as to be connected to a latching means of a tool. As a result it can be achievable, for example, that the sanitary insert part and the tool can be connected to one another. Alternatively or additionally, it can be provided that the sanitary insert part is designed with latching means and/or mating latching means so as to be releasably connected to a latching means and/or mating latching means of the tool. As a result it can be achievable, for example, that the connection between the sanitary insert part and the tool can be released. This is necessary, for example, upon assembly of the sanitary insert part in a sanitary fitting. Alternatively or additionally, it can be provided that the sanitary insert part is designed with latching means and/or mating latching means so as to be captively connected to a latching means and/or mating latching means of the tool. As a result it can be achievable, for example, that the sanitary insert part and the tool can be captively connected. This is advantageous for assembling, because the sanitary insert part is easier to connect to a sanitary fitting when said insert part has first been fastened to the tool. It is provided in particular that the sanitary insert part is designed with latching means and/or mating latching means so as to be, preferably releasably and/or captively, connected to a latching means or mating latching means of a tool having one or more of these features. As a result it can be achievable, for example, that the latching means and the mating latching means are of a mutually corresponding design, thus interact in a matching manner.

Alternatively or additionally, one or more of the features of directed toward a set consisting of a tool and a sanitary insert part, are provided according to the invention for achieving the object mentioned. Proposed for achieving the object is thus a set consisting of a tool and a sanitary insert part, wherein the tool is specified for assembling the sanitary insert part, characterized in that the tool for assembling is able to be captively connected to the sanitary insert part. As a result it can be achievable, for example, that a sanitary insert part can be captively connected to the tool. This is helpful during assembling, in particular while assembling in an oblique position or overhead, because the sanitary insert part thus cannot be unintentionally separated from the tool. It can be provided in particular that the sanitary insert part is a sanitary outlet orifice. Alternatively or additionally, it can be provided that the tool is specified for disassembling the sanitary insert part and is characterized in that for disassembling the tool is able to be captively connected to the sanitary insert part. As a result it can be achievable, for example, that a sanitary insert part can be captively connected to the tool. This is helpful during disassembling, in particular while disassembling in an oblique position or overhead, because the sanitary insert part thus cannot be unintentionally separated from the tool.

In one preferred design embodiment it can be provided that the captive connection between the tool and the sanitary insert part is performed by means of a form-fit. As a result it can be achievable, for example, that the form-fitting connection blocks any relative movement between the latching means and the mating latching means (and vice versa). In particular, the form-fitting connection can be a snap-fit connection. In the process, the latching element/mating latching element is deformed and establishes a releasable and/or captive connection with a corresponding mating latching element/latching element. Alternatively or additionally, it can be provided that the captive connection between the tool and the sanitary insert part is performed by means of a force-fit. As a result it can be achievable, for example, that the captive connection is achieved by high frictional forces acting between the latching element and the mating latching element. The force-fitting connection can in particular be an interference fit. As a result of a compressive force, the latching element/mating latching element is pressed into a corresponding receptacle, whereby the receptacle is somewhat too small, or the latching element/mating latching element is somewhat too large, respectively. As a result, the latching element/mating latching element is elastically deformed, and high frictional forces acting between the latching element/mating latching element and the receptacle lead to a captive connection. The form-fit and/or the friction-fit can be cancelled by a tensile force, thus by the tool pulling on the sanitary insert part.

Alternatively or additionally, the features directed toward a method for assembling and/or disassembling a sanitary insert part using a tool are provided according to the invention for achieving the object mentioned. It is thus provided in particular that the tool for assembling is captively connected to the sanitary insert part. As a result, a method for assembling a sanitary insert part using a tool can be achievable, for example, characterized in that the tool for assembling is captively connected to the sanitary insert part. It is advantageous herein that the sanitary insert part, when the latter is connected to the tool, cannot be lost. In contrast, it is captively connected to the tool. For assembling, the tool can be captively connected to the sanitary insert part, whereby the sanitary insert part is then disposed on the tool and by means of the latter can be fastened to a sanitary fitting. Alternatively or additionally, it can be provided that the tool for disassembling is captively connected to the sanitary insert part. As a result it can be achievable, for example, that the sanitary insert part is captively fastened to the tool during disassembling. During disassembling, for example unscrewing the sanitary insert part from a sanitary fitting, the sanitary insert part is always securely connected to the tool and cannot be lost when the connection between the sanitary insert part and the sanitary fitting is released.

A preferred application of the invention provides that a connection between the tool and the sanitary insert part is performed by means of a form-fit. As a result, a particularly stable and captive connection can be achieved, for example, in which it is prevented that the connection is unintentionally released. It is provided in particular that the form-fit is a snap-fit. Snap-fit connections represent a type of form-fitting connection which is simple in terms of construction. Alternatively or additionally, it can be provided that the connection between the tool and the sanitary insert part is performed by means of a force-fit. A force-fit resulting from friction between the latching element and the mating latching element represents a captive fastening which is of a simple construction and nevertheless is releasable. The force-fitting connection can in particular be an interference fit. As a result, a simple and captive connection between the latching element and the mating latching element can be possible, for example. The connection can be released by a tensile force acting on the tool.

A preferred application of the invention provides that for releasing the tool from the sanitary insert part a force greater than the weight force of the tool is applied. As a result it can be achievable, for example, that the tool can be released from the sanitary insert part when the force is greater than the weight force of the tool. It is provided in particular that a tensile force which is greater than the weight force of the tool is applied for releasing the tool from the sanitary insert part. As a result it can be achievable, for example, that the tool can be released from the sanitary insert part by extraction. However, the connection between the sanitary insert part and the tool is only cancelled once the tensile force exceeds the weight force of the tool. Any unintentional release is prevented in this way.

One preferred application of the invention provides that a first latching means of the tool interacts with a first mating latching means of the sanitary insert part. As a result, a torque can be transmitted from the tool to the sanitary insert part, for example. Alternatively or additionally, it can be provided that a second latching means of the tool interacts with a second mating latching means of the sanitary insert part. As a result it can be achievable, for example, that a particularly high torque can be transmitted from the tool to the sanitary insert part because both latching means interact with both mating latching means.

Alternatively or additionally, the features directed towards a use are provided according to the invention for achieving the object mentioned. It is thus proposed in particular that a previously described tool is used for applying a torque to a previously described sanitary insert part.

The tool is made of plastics material, this having the advantage that the tool is not as hard as (high-grade) steel or chromed applications of sanitary fittings and, therefore, cannot scratch the latter.

Deposits of dirt and limescale may arise in the air induction region in aerated sanitary insert parts. These deposits can be removed with the tool when the latching means/mating latching means of the tool engage in the air induction openings. In this way, an advantageous and uncomplicated removal of dirt can be performed with the tool, this improving the function of the sanitary insert part and extending the lifespan of the latter. In one design embodiment of the invention it can therefore be provided that the tool engages, or can engage, in the induction openings. In this way, the individual key webs can free the air induction region of dirt and limescale deposits.

### BRIEF DESCRIPTION OF THE DRAWINGS

The invention will now be described in more detail by means of exemplary embodiments, but is not limited to the exemplary embodiments. Further exemplary embodiments are derived by combining the features of individual, or a plurality of, claims with one another and/or with individual, or a plurality of, features of the exemplary embodiments.

In the figures:

FIG. 1 shows a tool with a jet regulator in a perspective view;

FIG. 2 shows the tool with the jet regulator from FIG. 1, in a lateral view;

FIG. 3 shows a detailed view of a connection between the tool and the jet regulator from FIG. 2;

FIG. 4 shows the tool from FIGS. 1-3;

FIG. 5 shows a tool with a jet regulator in a lateral view;

FIG. 6 shows a detailed view of a connection between the tool and the jet regulator from FIG. 5;

FIG. 7 shows a tool in a perspective view;

FIG. 8 shows a lateral sectional illustration of the tool from FIG. 7 and of a jet regulator;

FIG. 9 shows the tool with the jet regulator from FIGS. 7-8, in a lateral view;

FIG. 10 shows a tool in a perspective view;

FIG. 11 shows a lateral sectional illustration of the tool from FIG. 10 and of a jet regulator;

FIG. 12 shows the tool and the jet regulator from FIGS. 10-11, in a lateral view;

FIG. 13 shows a tool in a lateral view;

FIG. 14 shows a lateral sectional illustration of the tool from FIG. 13 and of a jet regulator;

FIG. 15 shows a detailed view of a connection between the tool and the jet regulator from FIG. 14;

FIG. 16 shows a tool in a perspective view;

FIG. 17 shows a lateral sectional illustration of the tool from FIG. 16 and of a jet regulator;

FIG. 18 shows a detailed view of a connection between the tool and the jet regulator from FIG. 17;

FIG. 19 shows the tool and the jet regulator from FIGS. 16-18, in a lateral view;

FIG. 20 shows a tool in a perspective view;

FIG. 21 shows the tool from FIG. 20 and a jet regulator in a lateral view; and

FIG. 22 shows a lateral sectional illustration of the tool and of the jet regulator from FIGS. 20-21.

### DETAILED DESCRIPTION

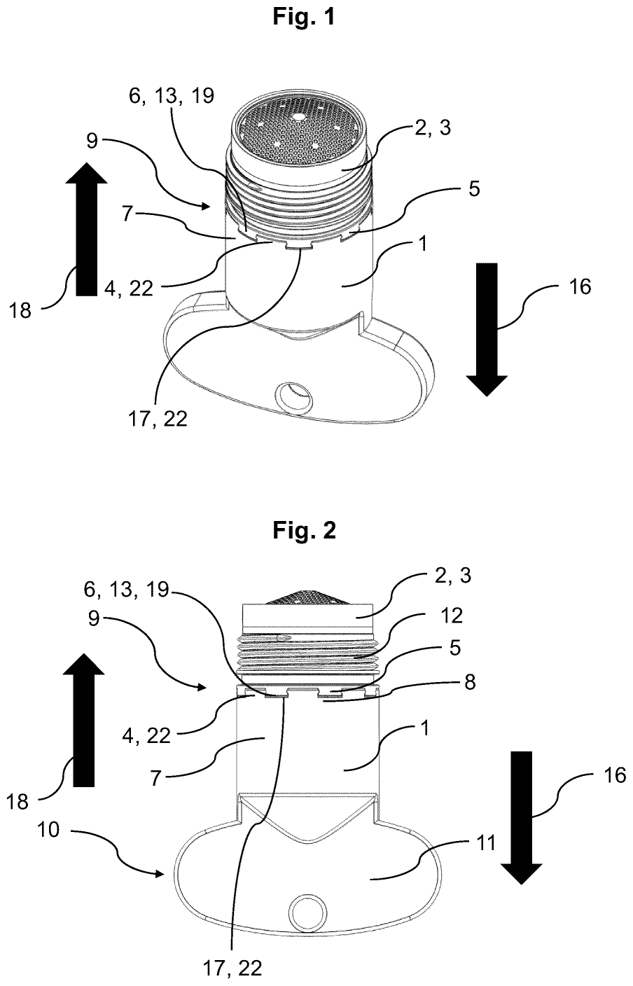

FIG. 1 shows a tool 1 for assembling and disassembling a sanitary insert part 2. This assembling/disassembling can include screwing in/unscrewing, for example. For this purpose, the tool 1 is specified to introduce a torque into the sanitary insert part 2 and to drive a rotating movement.

In this exemplary embodiment, the sanitary insert part 2 is a sanitary outlet orifice 3. The tool 1 has latching means 4 for a releasable and captive connection 6 to the sanitary insert part 2. The tool 1 has a drive portion 7 which is of a cylindrical shape. The latching means 4 is disposed on an encircling part 8 of one side 9 of the drive portion 7. The tool 1 has a handle 11 on a side 10 of the tool 1 that lies opposite the drive portion 7. The handle 11 serves to manually grip the sanitary insert part 2 and to transmit a torque to the latter. The handle 11 is designed in the shape of wings. Shown in the lateral view (FIG. 2) is a thread 12 of the sanitary insert part 2. The sanitary insert part 2 can be screwed into a sanitary fitting (not shown) using the tool 1.

In the exemplary embodiments shown, the drive portion 7 is designed with a wall. The drive portion has a consistent cross-sectional contour along its profile. In the exemplary embodiments shown, the drive portion is of a cylindrical shape. In an exemplary embodiment not shown, the drive portion is of a polygonal shape.

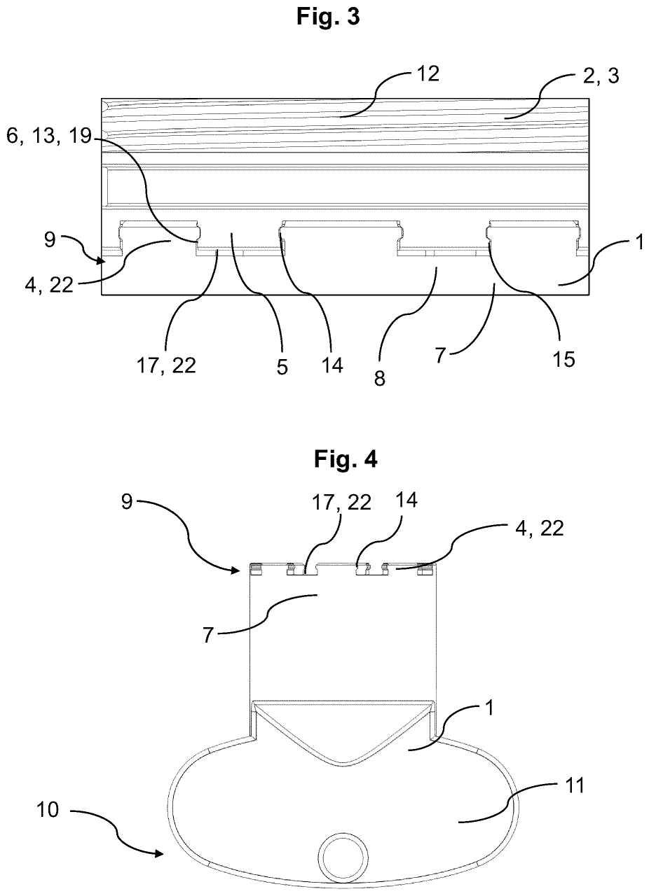

FIG. 3 shows the latching means 4 of the tool 1, which interacts with the mating latching means 5 of the sanitary insert part 2 and with the latter establishes a releasable and captive form-fitting snap-fit connection 13. FIG. 4 shows the tool 1 without the sanitary insert part 2. In order for the form-fitting snap-fit connection 13 to be able to be performed, the latching means 4 are pressed into receptacles of the sanitary insert part 2. Conversely, the mating latching means 5 of the sanitary insert part 2 are pressed into receptacles 17 of the tool 1. In the process, the latching cams 14 of the latching means 4 of the tool 1 are pressed against the mating latching cams 15 of the mating latching means 5 of the sanitary insert part 2. The latching means 4 and the mating latching means 5 are elastically deformed by being mutually compressed, in this way interlocking with one another. The connection 6 can be released again by a tensile force 16.

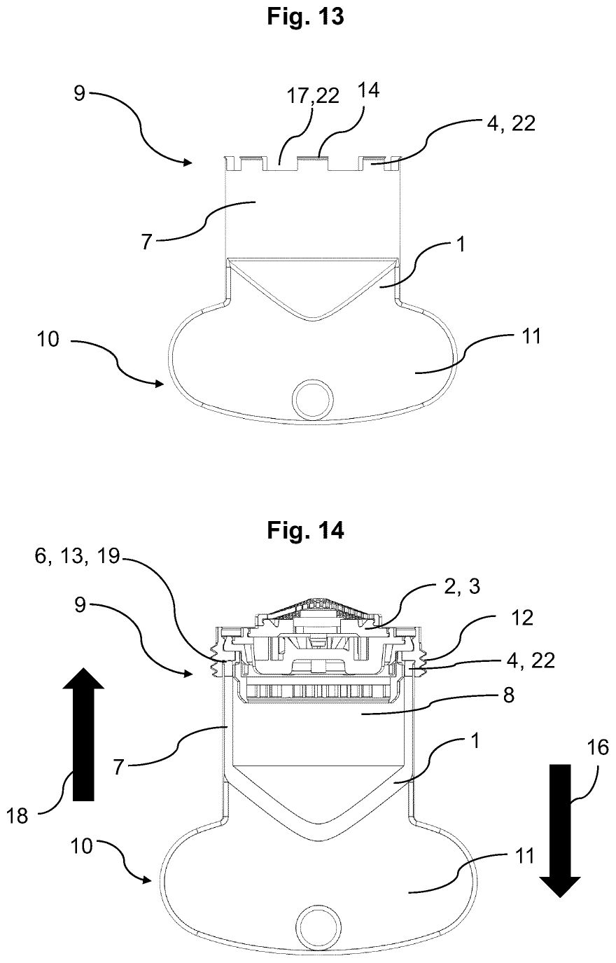

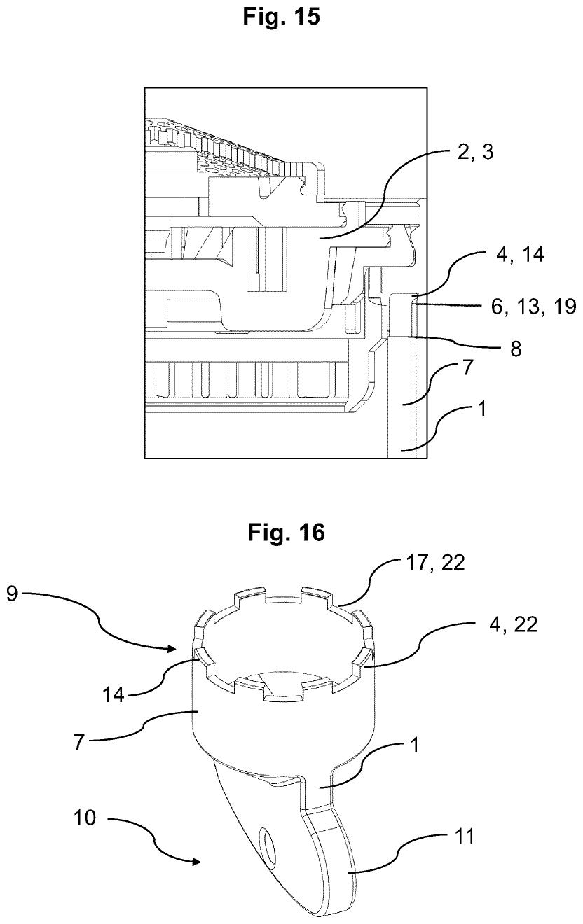

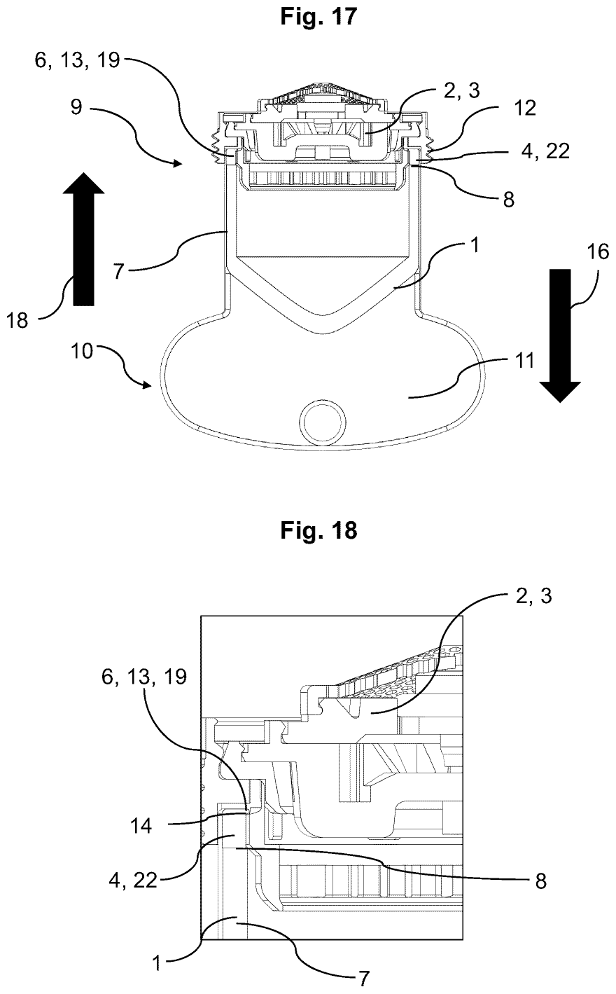

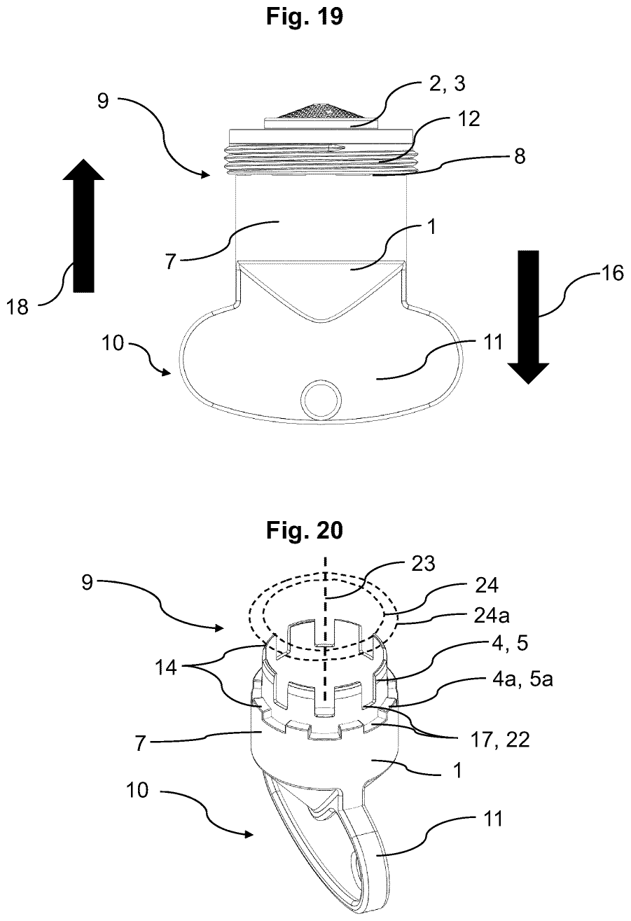

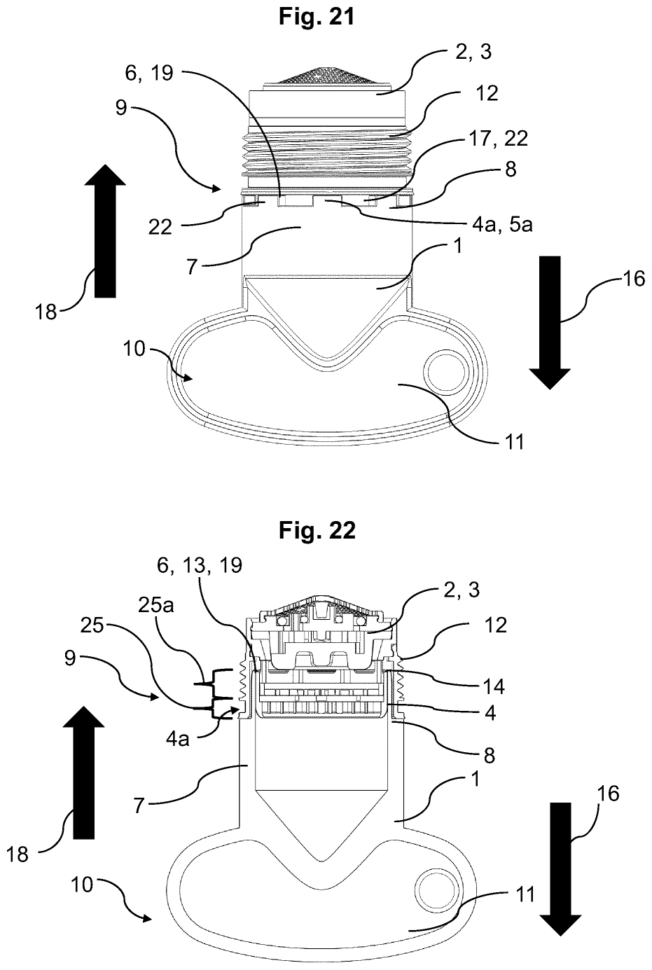

The sanitary insert part 2 is designed with mating latching means 5 so as to be releasably and captively connected to the latching means 4 of the tool 1. In the context of the patent document it is obvious that the latching means 4 and the mating latching means 5 are also present on the tool 1 and the sanitary insert part 2 in a reversed arrangement, depending on the point of view. The figures show a set consisting of the tool 1 and the sanitary insert part 2, wherein the sanitary insert part 2 is a sanitary outlet orifice 3. The tool 1 is specified for assembling and disassembling the sanitary insert part 2. For this purpose, the tool 1 is able to be captively connected to the sanitary insert part 2. The captive connection 6 is performed by means of a form-fit and/or force-fit. A form-fitting connection 19 is shown in FIGS. 1 to 4 and 13 to 22. Here, the captive connection 6 is performed by a snap-fit connection 13, thus a snap-fit, whereby the latching cam 14 of the tool 1 is elastically deformed. The latching cam 14 then latches to the sanitary insert part 2 and achieves a captive connection 6 which however is releasable by a tensile force. During the elastic deformation of the latching cam 14, this tensile force will initially increase as the distance increases and then abruptly drop once the connection 6 is released.

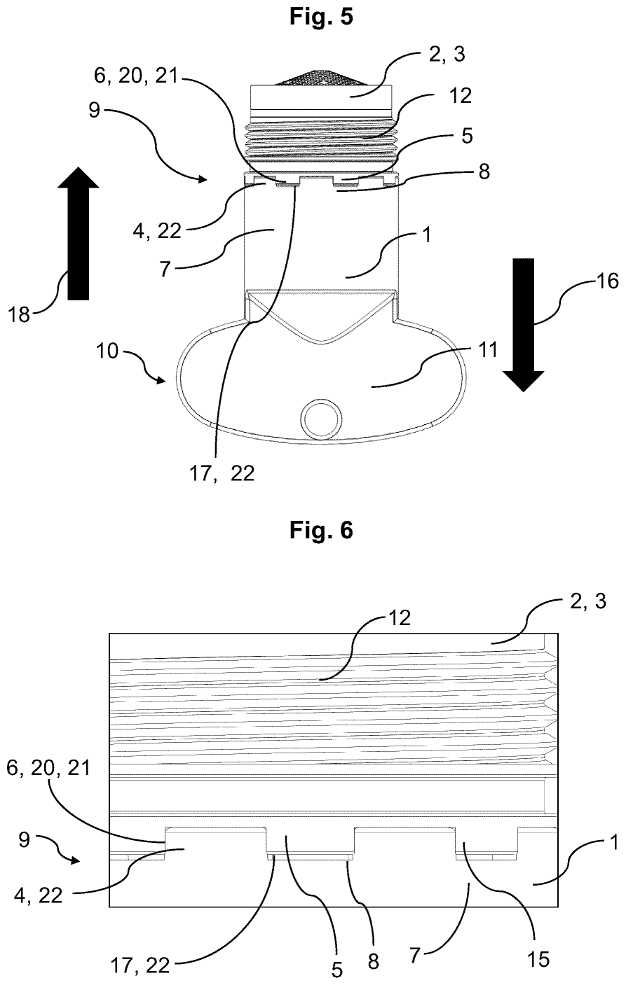

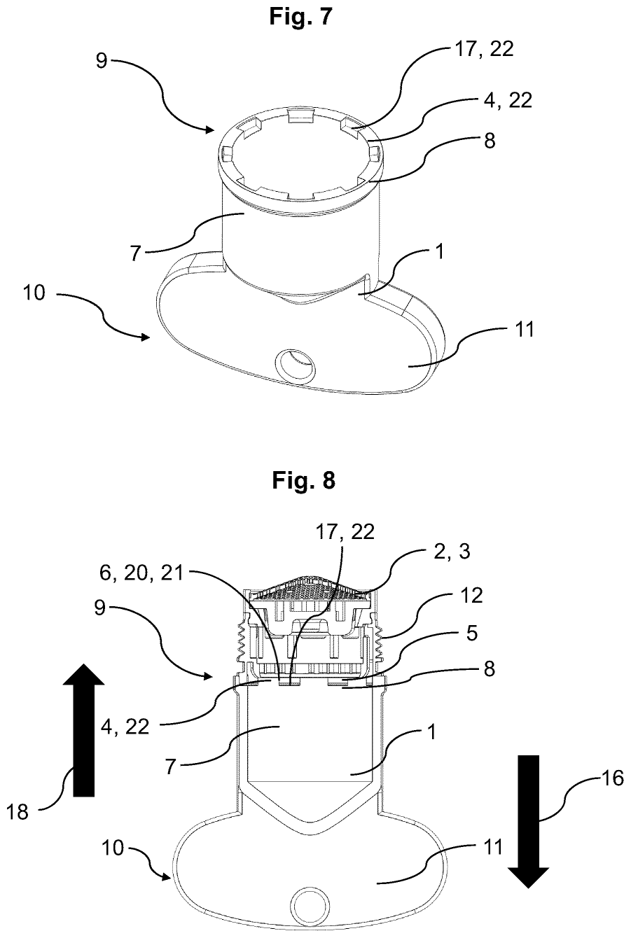

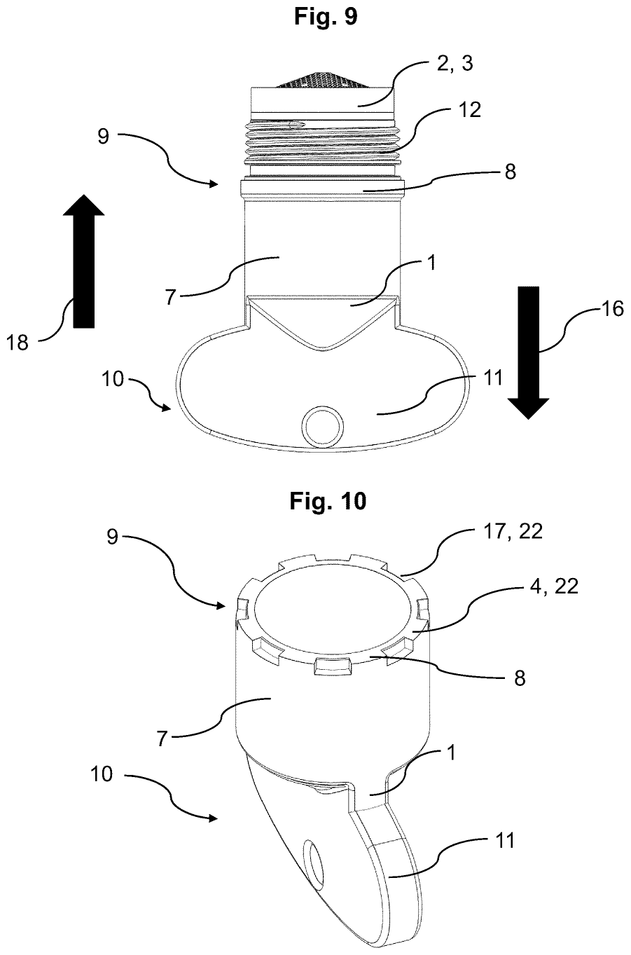

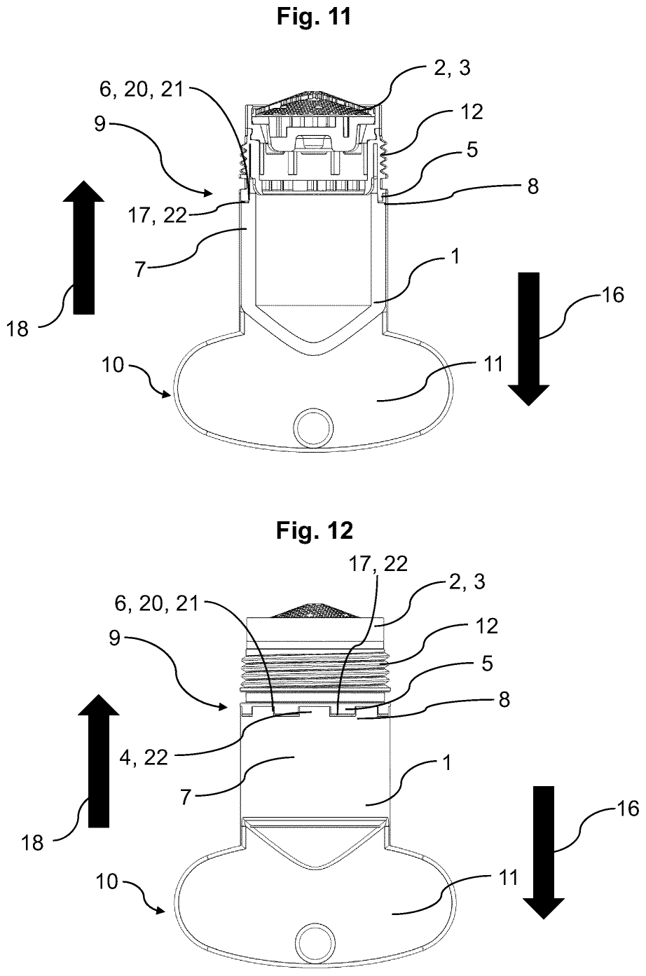

The captive connection 6 between the tool 1 and the sanitary insert part 2 is additionally or alternatively performed by a force-fit. A force-fitting connection 20 is shown in FIGS. 5 to 12. Here, the force-fit is implemented by an interference fit 21. In a force-fit, a minimum force is required for overcoming a static friction, this minimum force abruptly dropping in the transition to a dynamic friction.

Receptacles 17 on the drive portion 7 of the tool 1 for the mating latching means 5 of the sanitary insert part are designed to be somewhat smaller than the mating latching means 5 of the sanitary insert part 2. The mating latching means 5 can be pressed into the receptacles 17 by a compressive force 18, this resulting in the force-fitting connection 20 due to the interference fit 21.

A method for assembling the sanitary insert part 2 using the tool 1, wherein the tool 1 for assembling is captively connected to the sanitary insert part 2, comprises the following steps. The tool 1 is connected to the sanitary insert part 2 by a compressive force 18. For this purpose, both parts are preferably held in the hands of a user. The latching means 4/mating latching means 5 are inserted into corresponding receptacles 17. Upon connection, the sanitary insert part 2 is captively connected to the tool 1 and can be moved conjointly with the latter. The tool 1 and the sanitary insert part 2 are then offered up and tightly screwed to an outlet of a sanitary fitting. The latching means 4 and the mating latching means 5 permit a transmission of force from the tool 1 to the sanitary insert part 2.

A method for disassembling the sanitary insert part 2 using the tool 1, wherein the tool 1 for assembling is captively connected to the sanitary insert part 2, comprises the following steps. The tool 1 is connected to the sanitary insert part 2 by a compressive force 18, the sanitary insert part 2 being located in the outlet of a sanitary fitting. Upon connection, the sanitary insert part 2 is captively connected to the tool 1 and can be moved conjointly with the latter. The sanitary insert part 2 can be unscrewed from the sanitary fitting by a rotating movement.

During assembling and disassembling, the connection between the tool 1 and the sanitary insert part 2 is performed by a form-fit and/or force-fit. A tensile force 16 which is greater than the weight force of the tool 1 has to be applied in order to release the tool 1 from the sanitary insert part 2.

The tool 1 is designed with a crown structure 22 which serves to transmit the torque from the tool 1 to the sanitary insert part 2. The torque can be transmitted at the point where the latching means 4 and the mating latching means 5 are in contact on the crown structure 22. The latching means 4 and the receptacles 17 of the tool 1 are part of the crown structure 22. The drive portion 7 of the tool 1 is of a hollow design. In an embodiment not shown, the drive portion 7 is of a solid design.

FIGS. 20 to 22 show a tool 1 having two latching means 4, 4a and two mating latching means 5, 5a. The two latching means 4, 4a and the two mating latching means 5, 5a are differently spaced apart from an axial axis 23 of the tool 1. The first latching means 4 is closer to the axial axis 23 of the tool 1 than the second latching means 4a. The two mutually spaced apart circular paths 24, 24a, plotted with dashed lines, illustrate the arrangement of the latching means 4, 4a and the mating latching means 5, 5a. FIG. 22 shows that the two latching means 4a, 4 have different longitudinal extents 25, 25a in the axial direction of the tool 1.

Proposed are a tool 1 and a method for assembling and/or for disassembling a sanitary insert part 2, in particular a sanitary outlet orifice 3, characterized in that the tool 1 is designed with latching means 4 and/or mating latching means 5 for a preferably releasable and/or captive connection 6 to the sanitary insert part 2.

### LIST OF REFERENCE SIGNS

1 Tool
2 Sanitary insert part
3 Sanitary outlet orifice
4 Latching means
4a Latching means
5 Mating latching means
5a Mating latching means
6 Connection
7 Drive portion
8 Encircling part
9 Side
10 Opposite side
11 Handle
12 Thread
13 Snap-fit connection
14 Latching cams
15 Mating latching cams
16 Tensile force
17 Receptacles
18 Compressive force
19 Form-fitting connection
20 Force-fitting connection
21 Interference fit
22 Crown structure
23 Axial axis
24 Circular path
24a Circular path
25 Longitudinal extent
25a Longitudinal extent

1. A tool (1) for assembling and/or for disassembling a sanitary insert part (2), wherein the tool (2) is specified to input a rotating movement and/or a torque into the sanitary insert part (2), the tool (1) comprising:
a drive portion (7); and
at least one of latching means (4) or mating latching means (5) on the drive portion (7) for a releasable and/or captive connection (6) to the sanitary insert part (2).

2. The tool (1) according to claim 1, wherein the drive portion (7) comprises a wall, having a consistent cross-sectional contour with at least one of a cylindrical or polygonal shape.

3. The tool (1) according to claim 1, wherein at least one of the latching means (4) or the mating latching means (5) are disposed on one side (9) of the drive portion (7).

4. The tool (1) according to claim 1, wherein the tool includes at least two of the latching means (4, 4a) or two of the mating latching means (5, 5a).

5. The tool (1) according to claim 4, wherein the two latching means (4, 4a) or the two mating latching means (5, 5a) are differently spaced apart from an axial axis (23) of the tool (1).

6. The tool (1) according to claim 4, wherein the two latching means (4, 4a) and/or the two mating latching means (5, 5a) are disposed on two mutually spaced apart circular paths (24, 24a) about an axial axis (23) of the tool (1).

7. The tool (1) according to claim 4, wherein the two latching means (4, 4a) and/or mating latching means (5, 5a) have different longitudinal extents (25, 25a) in an axial direction of the tool (1).

8. A sanitary insert part (2), comprising a body including at least one of latching means (4) or mating latching means (5) that are adapted to be releasably and/or captively connected to at least one of the latching means (4) or the mating latching means (5) of the tool (1) according to claim 1.

9. A set comprising:
a tool (1),
a sanitary insert part (2),
wherein the tool (1) is specified for at least one of assembling or for disassembling the sanitary insert part (2), and
the tool (1) for the at least one of assembling or for disassembling is configured for a captive connection to the sanitary insert part (2).

10. The set according to claim 9, wherein the captive connection (6) between the tool (1) and the sanitary insert part (2) includes at least one of a form-fit (19), a snap-fit (13), or a force-fit (20), or an interference fit (21).

11. A method for assembling and/or disassembling a sanitary insert part (2) using a tool (1), the method comprising:
providing a tool (1) specified for at least one of assembling or for disassembling the sanitary insert part (2), and
captively connecting the tool (1) to the sanitary insert part (2) for the at least one of assembling or disassembling.

12. The method according to claim 11, wherein a connection between the tool (1) and the sanitary insert part (2) is performed by at least one of a form-fit (19), a snap-fit (13), a force-fit (20), or an interference fit (21).

13. The method according to claim 11, further comprising releasing the tool (1) from the sanitary insert part (2) by applying a force greater than a weight force of the tool (1).

14. The method according to claim 11, further comprising the captively connecting including a first latching means (4) of the tool (1) interacting with a first mating latching means (5) of the sanitary insert part (2).

15. The method according to claim 14, further comprising a second latching means (4a) of the tool (1) interacting with a second mating latching means (5a) of the sanitary insert part (2).
